(19) United States
(12) Patent Application Publication
(10) Pub. No.: US 2016/0372279 A1
(43) Pub. Date: Dec. 22, 2016

(54) CONTROL DEVICE AND IMAGE DISPLAY SYSTEM

(71) Applicant: SEIKO EPSON CORPORATION, Tokyo (JP)

(72) Inventors: Yoko YAMAZAKI, Ueda-shi (JP); Takeshi FUJISHIRO, Shiojiri-shi (JP)

(73) Assignee: SEIKO EPSON CORPORATION, Tokyo (JP)

(21) Appl. No.: 15/174,282

(22) Filed: Jun. 6, 2016

(30) Foreign Application Priority Data
Jun. 19, 2015 (JP) 2015-123643

(51) Int. Cl. H01H 13/06; G02B 27/01

(52) U.S. Cl. CPC H01H 13/06; G02B 27/0176; G02B 2027/0178

(57) ABSTRACT

A control device includes: key tops on which an input operation is performed; a circuit substrate that includes detection section which detect that the key tops are pressed on a substrate surface which faces the key tops; a device main body that outputs a signal based on a result of detection performed by the detection section; and an elastic member that covers approximately the whole area of the substrate surface and is arranged between the substrate surface and the key tops.

### BACKGROUND

1. Technical Field

The present invention relates to a control device and an image display system.

2. Related Art

In the related art, a head-mounted display apparatus, which is mounted on the head of a user and is referred to as an HMD, is known (for example, refer to JP-A-2014-165893).

A head-mounted display apparatus disclosed in JP-A-2014-165893 includes a glass-shaped image display section that causes a user to visually recognize a virtual image in a state of being mounted on the head of the user, and a control section that controls an operation of the image display section. Here, the control section includes a plurality of keys (an electric power source key, a direction key, a determination key, and the like) which receives an operation performed by the user. Furthermore, the control section performs processes according to input operations (pressing down operation) of these keys, performs a prescribed image process on image data according to an image signal which is acquired from an external device, and drives the display section according to the image data.

In recent years, the use of the head-mounted display apparatus has expanded, and there is a case in which the head-mounted display apparatus is used not only to watch a movie or the like in a room but also to post a manual for workers who work in a plant or an outdoor place. However, the control section of the head-mounted display apparatus disclosed in JP-A-2014-165893 does not have a waterproofing and dustproofing structure. Therefore, if water and dust adhere to the control section, there is a possibility that water and dust enter inside the control section.

### SUMMARY

An advantage of some aspects of the invention is to provide a control device and an image display system which are capable of improving waterproof properties and dustproof properties.

A control device according to a first aspect of the invention includes: key tops on which an input operation is performed; a circuit substrate that includes a detection section which detects that the key tops are pressed on a substrate surface which faces the key tops; a device main body that is connected to the circuit substrate and is configured to output a signal based on a result of detection performed by the detection section; and an elastic member that covers approximately the whole area of the substrate surface and is arranged between the substrate surface and the key tops.

According to the first aspect, since approximately the whole area of the substrate surface, which includes the detection section, is covered by the elastic member, it is possible to suppress water and dust from adhering to the substrate surface even in a case in which water and dust adhere to the control device. Accordingly, it is possible to improve the waterproof properties and the dustproof properties.

In the control device according to the first aspect, it is preferable that waterproofing and dustproofing of each of the circuit substrate and the device main body are accomplished in such a way that the elastic member covers at least a part of the device main body.

According to the first aspect with this configuration, it is possible to suppress water and dust from adhering to the device main body in addition to the circuit substrate by the elastic member.

In the control device according to the first aspect, it is preferable that the device main body is arranged on the circuit substrate on a side opposite to the substrate surface, the device main body includes a side surface section that is located in a direction perpendicular to a direction in which the device main body faces the circuit substrate, and the elastic member includes a first elastic section that covers the substrate surface, and a second elastic section that is integrally formed with the first elastic section and is configured to cover the side surface section.

According to the first aspect with this configuration, since the side surface section of the device main body is covered by the second elastic section of the elastic member, it is possible to suppress water and dust from directly adhering to the side surface section, and it is possible to suppress water and dust from entering inside the device main body through the side surface section. In addition, it is possible to relieve shocks, which are given from the side of the side surface section to the device main body, by the second elastic section, and it is possible to improve shock resistance.

In addition, since the second elastic section is integrally formed with the first elastic section which covers the substrate surface, it is possible to reduce the number of components compared to a case in which the first elastic section and the second elastic section are formed by separate components. In addition, there is no case in which water and dust enter from the boundary between the first elastic section and the second elastic section.

In the control device according to the first aspect, it is preferable that a thickness dimension of the second elastic section is greater than a thickness dimension of the first elastic section.

According to the first aspect with this configuration, it is possible to suppress the thickness dimension of the control device (dimension in a direction in which the device main body and the circuit substrate face each other) from increasing, and it is possible to sufficiently secure shock resistance to shocks which are given to the device main body from the side of the side surface section.

In the control device according to the first aspect, it is preferable that the device main body includes a waterproofing sheet that is arranged on a side of the circuit substrate.

According to the first aspect with this configuration, it is possible to suppress water and dust from entering inside the device main body from a side which faces the circuit substrate in the device main body. Accordingly, it is possible to protect the control substrate or the like which is located in the device main body.

In the control device according to the first aspect, it is preferable that the device main body is located on a side opposite to the circuit substrate, and is configured to include storage sections that store batteries, and the control device is installed to be detachable from the device main body and is configured to include a battery cover which covers the storage sections.

According to the first aspect with this configuration, it is possible to protect the batteries which are stored in the storage sections. Meanwhile, if an elastic body, such as rubber, is arranged on a contact surface between the battery cover and the device main body, it is possible to suppress water and dust from entering into the storage sections.

In the control device according to the first aspect, it is preferable that the key tops include protruding sections that protrude on a side of the elastic member, and the elastic member includes standing sections that are configured to stand on a side of the key tops and are formed with recess sections into which the protruding sections are inserted.

According to the first aspect with this configuration, it is possible to support the key tops by the elastic member in such a way that the protruding sections of the key tops are inserted into the recess sections of the elastic member. Thereby, it is possible to reduce the number of components compared to a case in which components that support the key tops are separately provided, and it is possible to easily install the key tops in the elastic member.

In the control device according to the first aspect, it is preferable that the control device further includes a cover member that is arranged on a side opposite to the circuit substrate while interposing the elastic member, and is configured to include an opening section in which the key tops are arranged inside, the elastic member includes a protruding frame section that protrudes on a side of the cover member and has a frame shape which surrounds the key tops when viewed from the side of the cover member, and a tip of the protruding frame section in a protruding direction adheres closely to the cover member.

According to the first aspect with this configuration, it is possible to prevent water and dust, which intrude from between the key tops and the opening section, from moving to the outside from inside the protruding frame section through the surface of the elastic member. Therefore, it is possible to suppress the water and dust from adhering to the circuit substrate from the hole section (for example, hole section into which a fixing member which fixes the elastic member, the circuit substrate, or the like is inserted) which is formed on the outside of the protruding frame section in the elastic member.

In addition, it is possible to protect the substrate surface by the cover member from the shocks given from the outside.

In the control device according to the first aspect, it is preferable that the control device further includes a cover member that includes an opening section that is arranged on a side opposite to the circuit substrate while interposing the elastic member and in which the key tops are arranged inside, the cover member includes a fixing section which protrudes on a side of the elastic member, the elastic member includes a hole section into which the fixing section is inserted, the cover member and the elastic member are fixed to the device main body in such away that the fixing section which is inserted into the hole section is engaged with the device main body, and the elastic member and the cover member adhere closely to each other.

According to the first aspect with this configuration, it is possible to easily fix the cover member and the elastic member to the device main body. In addition, since the elastic member adheres closely to the cover member, it is possible to suppress water and dust from intruding from between the elastic member and the cover member.

An image display system according to a second aspect of the invention includes: the control device described above; and an image display device that is mounted on a location corresponding to the head of a user, and is configured to operate according to a signal which is input from the control device.

It is possible to provide the upper portion of the head, which includes a forehead section, temporal sections, an occipital section, and a parietal section, as a part of the head on which the image display device is mounted. Here, in a case in which the user wears a helmet, a cap, or the like, it is possible to set the upper portion of the head to a location corresponding to the upper part in the helmet, the cap, or the like. That is, if the image display device is arranged in the location corresponding to the head of the user, the image display device may be directly mounted on the head or a component, such as the helmet or the cap, may be interposed between the head and the image display device.

According to the second aspect, it is possible to acquire the same advantage as that of the control device according to the first aspect.

### BRIEF DESCRIPTION OF THE DRAWINGS

The invention will be described with reference to the accompanying drawings, wherein like numbers reference like elements.

FIG. 1 is a diagram illustrating an image display system according to an embodiment of the invention.

FIG. 2 is a perspective diagram illustrating a control device viewed from the side of a front surface according to the embodiment.

FIG. 3 is a perspective diagram illustrating a control device viewed from the side of a rear surface according to the embodiment.

FIG. 4 is an exploded perspective diagram illustrating the control device viewed from the side of the front surface according to the embodiment.

FIG. 5 is an exploded perspective diagram illustrating the control device viewed from the side of the rear surface according to the embodiment.

FIG. 6 is a sectional diagram illustrating the control device viewed from the side of a right side surface according to the embodiment.

FIG. 7 is a sectional diagram illustrating the control device viewed from the side of a bottom surface side according to the embodiment.

FIG. 8 is an enlarged diagram illustrating a part in the vicinity of key tops in FIG. 6.

### DESCRIPTION OF EXEMPLARY EMBODIMENTS

Hereinafter, an embodiment of the invention will be described based on the accompanying drawing.

### Configuration of Image Display System

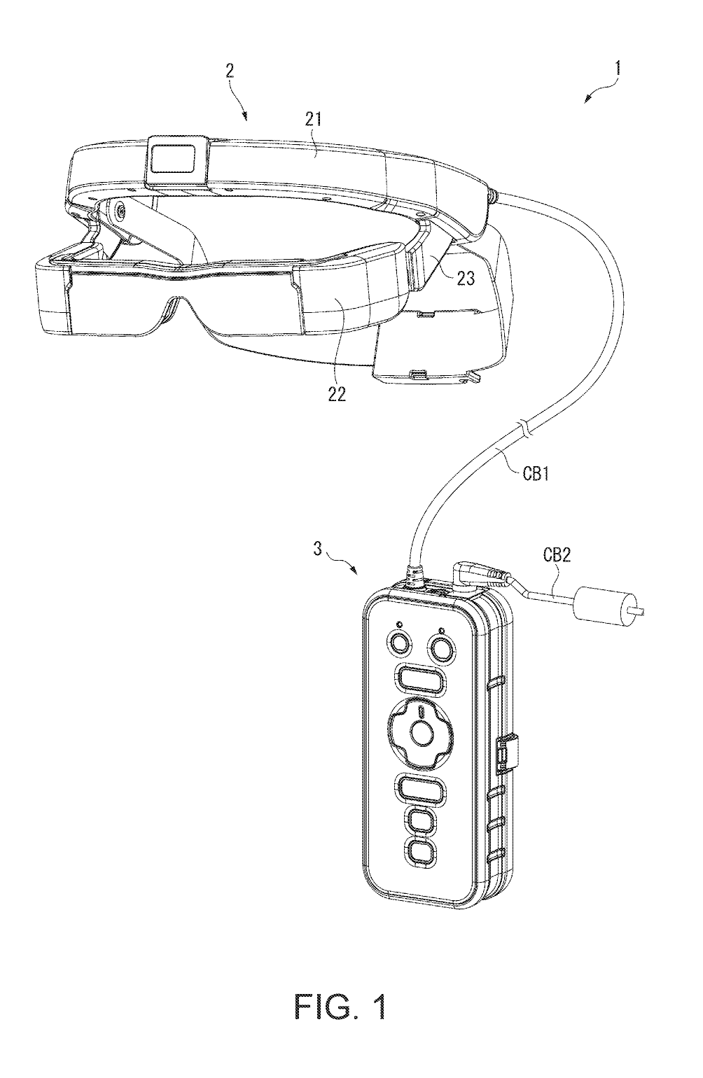

FIG. 1 is a diagram illustrating the configuration of an image display system 1 according to an embodiment of the invention.

The image display system 1 according to the embodiment includes an image display device 2 and a control device 3. Furthermore, the image display system 1 causes a user who wears the image display device 2 to visually recognize an virtual image in such a way that the image display device 2 operates according to a control signal (including an operation signal and an image signal) which is transmitted from the control device 3.

Hereinafter, each configuration will be described in detail.

### Configuration of Image Display Device

The image display device 2 as an electronic device includes a Head Mounted Display (HMD) which is used by being mounted on the head of the user, a helmet, or the like. The image display device 2 includes a head band section 21 which is mounted in a location (specifically, an upper portion of the head) corresponding to the head in the head of the user, the helmet, or the like, a display section 22 which causes the user to visually recognize an image as a virtual image, and an arm section 23 which connects the head band section 21 and the display section 22.

Here, the display section 22 causes image light (light which forms an image according to the image signal) according to an image signal, which is transmitted from the control device 3 to the head band section 21 through a cable CB1, to be incident into the eyes of the user, and causes an image, which is formed by the image light, to be visually recognized as a virtual image. In addition, the display section 22 is formed to make outdoor light to permeate and enable the user to observe an external world image. That is, the image display device 2 is formed as a see-through-type HMD.

### Configuration of Control Device

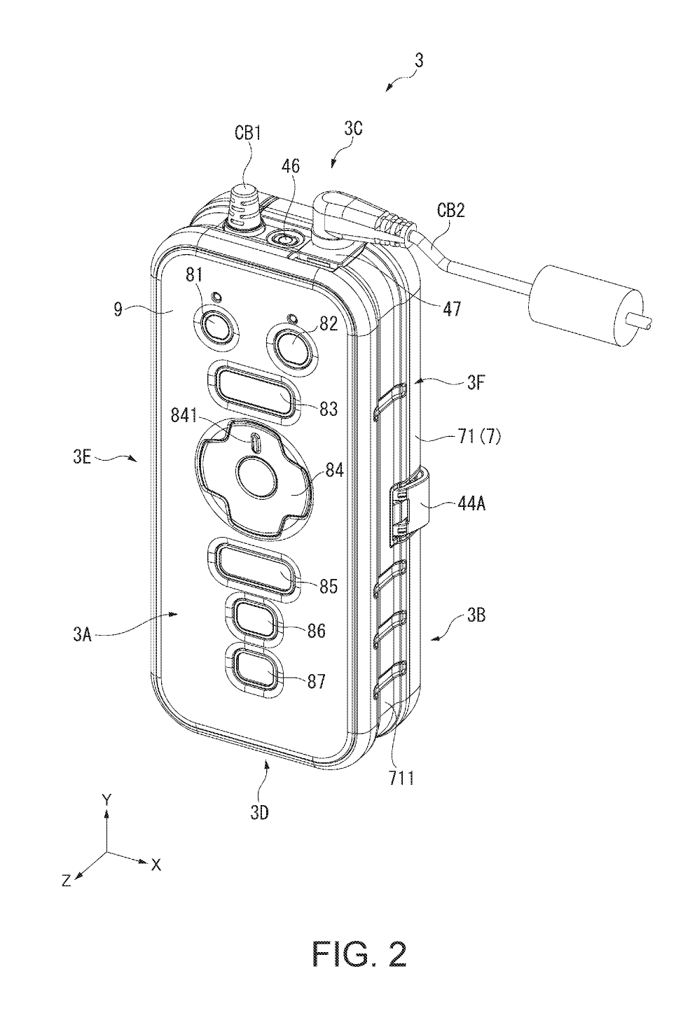

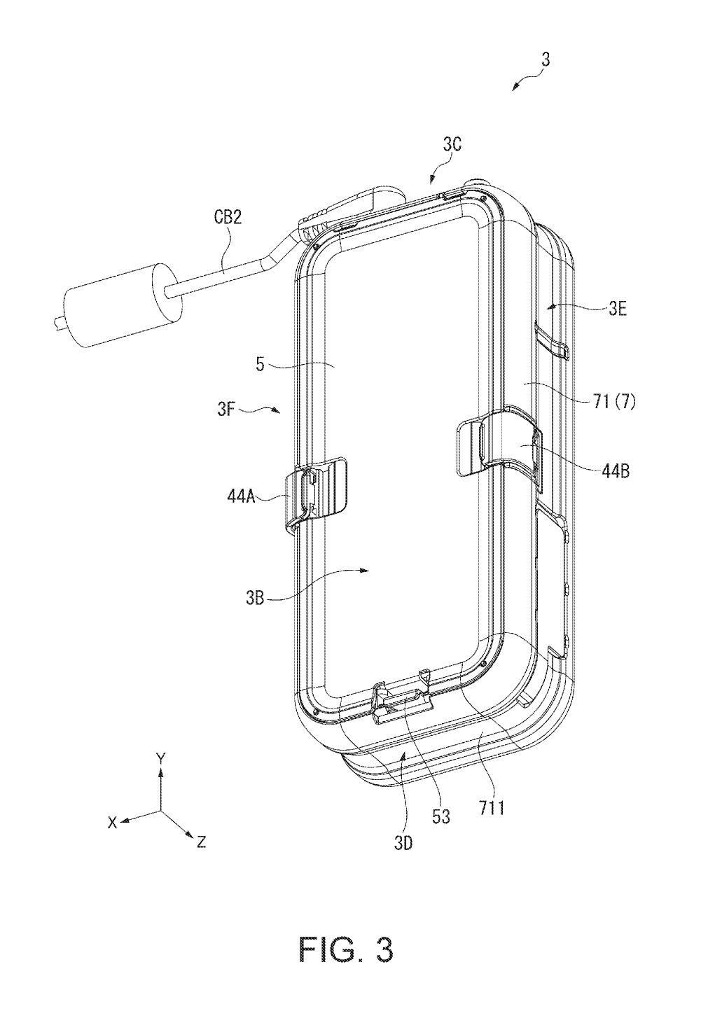

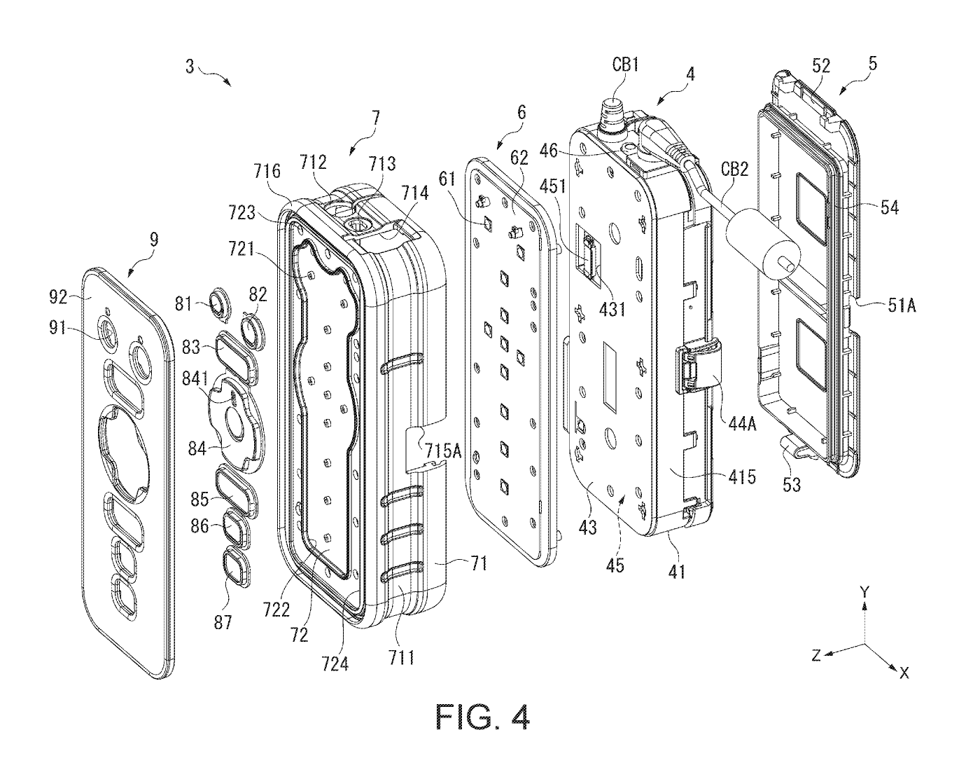

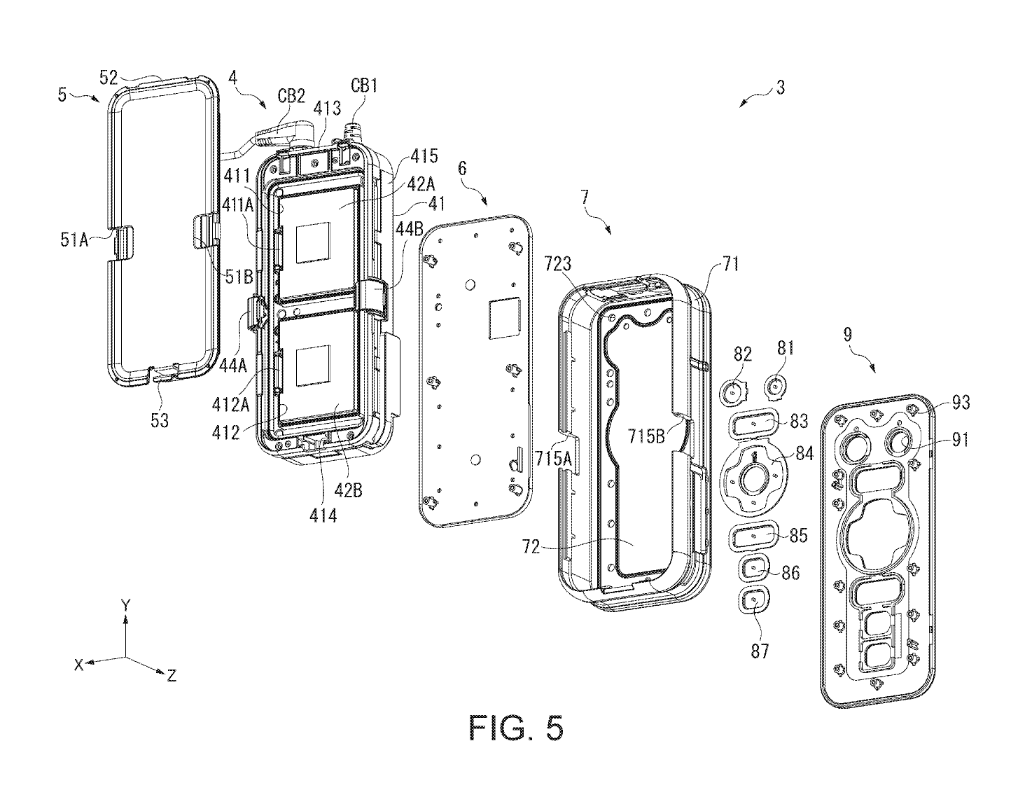

FIG. 2 is a perspective diagram illustrating the control device 3 viewed from the side of a front surface, and FIG. 3 is a perspective diagram illustrating the control device 3 viewed from the side of a rear surface. In addition, FIG. 4 is an exploded perspective diagram illustrating the control device 3 from the side of the front surface, and FIG. 5 is an exploded perspective diagram illustrating the control device 3 viewed from the side of the rear surface.

The control device 3 has an approximately rectangular parallelepiped shape as illustrated in FIGS. 2 to 5. The control device 3 includes a front surface 3A which has key tops 81 to 87, and a rear surface 3B which is on a side opposite to the front surface 3A. Furthermore, the control device 3 includes an upper surface 3C, which is perpendicular to the front surface 3A and the rear surface 3B and to which the cable CB1 is extended, and a bottom surface 3D which is on a side opposite to the upper surface 3C. Furthermore, the control device 3 includes a right side surface 3E, which is perpendicular to the front surface 3A, the rear surface 3B, the upper surface 3C, and the bottom surface 3D and which is located on the right side when viewed from the side of the rear surface 3B in a state in which the control device 3 is arranged such that the upper surface 3C becomes the top, and a left side surface 3F which is on a side opposite to the right side surface 3E.

Meanwhile, in the description below, a direction which faces the front surface 3A from the side of the rear surface 3B of the control device 3 is a Z direction, a direction which faces the left side surface 3F from the right side surface 3E of the control device 3 is an X direction, and a direction which faces the upper surface 3C from the bottom surface 3D of the control device 3 is a Y direction.

The control device 3 includes the cable CB1, an device main body 4, a battery cover 5, a circuit substrate 6 which includes switching elements 61, an elastic member 7 which covers the device main body 4 and the circuit substrate 6, the key tops 81 to 87, and a cover member 9, as illustrated in FIGS. 2 to 5.

### Configuration of Device Main Body

The device main body 4 is connected to the cable CB1 on a surface of the Y direction, and controls the operation of the image display device 2 through the cable CB1.

The device main body 4 includes a housing 41, a control substrate 45 on which a control circuit is mounted, two secondary batteries 42A and 42B, such as a lithium ion battery, a waterproofing sheet 43, engagement pawls 44A and 44B, a microphone 46, and a connection section 47 which can be connected to a cable CB2 of an AC adaptor.

The housing 41 is embedded with the control substrate 45. In addition, the housing 41 includes storage sections 411 and 412 which are open on a side opposite to the Z direction, and stores the secondary batteries 42A and 42B in the storage sections 411 and 412. The storage sections 411 and 412 are located to be aligned along the Y direction. In addition, the storage sections 411 and 412 include battery engagement sections 411A and 411B which are engaged with the secondary batteries 42A and 42B at end sections of the X direction, and are configured to fix the secondary batteries 42A and 42B.

In addition, the housing 41 includes engagement sections 413 and 414, which are engaged with engagement sections 52 and 53, which will be described later, of the battery cover 5, on a side, which is opposite to the Z direction, at an end section of the Y direction and on a side, which is opposite to the Z direction, at an end section in a direction opposite to the Y direction.

The control substrate 45 transmits the control signal, which includes an operation signal and image information, to the image display device 2 through the cable CB1 based on a detection signal which will be described later and which is output from the circuit substrate 6 according to input operation of the key tops 81 to 87, thereby controlling the operation of the image display device 2. Here, the control signal corresponds to a signal based on a result of detection performed by a detection section according to the invention.

The control substrate 45 includes a connector 451 which is connected to the circuit substrate 6. Furthermore, the detection signal, which is output from the circuit substrate 6, is input to the control substrate 45 through the connector 451.

In addition, the control substrate 45 supplies electric power, which is accumulated in the secondary batteries 42A and 42B, to the image display device 2 through the cable CB1.

In addition, the control substrate 45 charges the secondary batteries 42A and 42B with electric power which is supplied from the AC adaptor through the connection section 47.

The engagement pawls 44A and 44B are engaged with engagement ditches 51A and 51B, which will be described later, of the battery cover 5, and configured to fix the battery cover 5 to the housing 41.

The engagement pawls 44A and 44B are rotatably attached to surfaces of the housing 41 in the X direction and a direction which is opposite to the X direction, respectively, and are operated by the user. The engagement pawls 44A and 44B protrude toward the outside of the housing 41, when viewed from a direction along the Z direction, for easy operation of the user.

Meanwhile, FIGS. 2 and 3 illustrate a state in which the engagement pawl 44A is open and is not engaged with the engagement ditch 51A. However, in a case in which the control device 3 is used, the engagement pawl 44A is closed and is engaged with the engagement ditch 51A similarly to the engagement pawl 44B.

The waterproofing sheet 43 covers a surface of the housing 41 in the Z direction and adheres closely to the housing 41, thereby preventing water or dust from entering into the housing 41. The waterproofing sheet 43 is formed of, for example, an elastic body such as rubber. In addition, the waterproofing sheet 43 includes an insertion hole 431 for inserting the connector 451 of the control substrate 45.

Meanwhile, the microphone 46 and the connection section 47 are provided on a surface of the device main body 4 in the Y direction.

### Configuration of Battery Cover

The battery cover 5 covers a surface (the rear surface of the device) of the device main body 4 on a side opposite to the Z direction, and is detachably attached to the device main body 4. That is, the battery cover 5 covers the storage sections 411 and 412 which store the secondary batteries 42A and 42B of the device main body 4, and protects the secondary batteries 42A and 42B.

The battery cover 5 includes the engagement sections 52 and 53 which are engaged with the engagement sections 413 and 414 of the housing 41, and the engagement ditches 51A and 51B which are engaged with the engagement pawls 44A and 44B. The engagement sections 52 and 53 are located in an end section of the Y direction and an end section in a direction opposite to the Y direction. The engagement ditches 51A and 51B are located in an end section of the X direction and an end section in a direction opposite to the X direction.

The engagement sections 52 and 53 are engaged with the engagement sections 413 and 414 and the engagement ditches 51A and 51B are engaged with the engagement pawls 44A and 44B, and thus the battery cover 5 is fixed to the device main body 4.

Meanwhile, the battery cover 5 includes the elastic body 54 (seal member), such as rubber, which prevents water and dust from entering into the storage sections 411 and 412, on a contact surface with the device main body 4.

### Circuit Substrate

The circuit substrate 6 detects that the key tops 81 to 87 are pressed, and outputs a detection signal to the device main body 4.

The circuit substrate 6 covers the surface (device surface) of the device main body 4 in the Z direction, that is, the surface of the waterproofing sheet 43 in the Z direction. The circuit substrate 6 includes a plurality of switching elements 61 as the detection section according to the invention on a substrate surface 62 which is a surface in the Z direction. In the embodiment, a membrane switch is used as the switching elements 61. The switching elements 61 are arranged at locations corresponding to the key tops 81 to 87. If the key tops 81 to 87 are pressed, the switching elements 61 are pressed by the key tops 81 to 87 through the elastic member 7, and thus a switching state is changed from an OFF state to an ON state. Therefore, the switching elements 61 detect that the key tops 81 to 87 are pressed. Furthermore, if the switching elements 61 detect that any one of the key tops 81 to 87 is pressed, the circuit substrate 6 outputs a detection signal, which is a result of the detection, to the control substrate 45 of the device main body 4 through the connector 451.

### Elastic Member

The elastic member 7 is formed of rubber or the like, covers a side surface section 415 of the device main body 4 (the surface in the X direction, the surface on the side opposite to the X direction, the surface in the Y direction, the surface on the side opposite to the Y direction) and the substrate surface 62 of the circuit substrate 6, and prevents water and dust from adhering to the device main body 4 and the circuit substrate 6.

The elastic member 7 includes a cylindrical side wall section 71 (second elastic section) which has openings in the Z direction and the side opposite to the Z direction, and a front surface section 72 (first elastic section) which covers the opening on the side wall section 71 in the Z direction and is integrally formed with the side wall section 71.

The side wall section 71 covers the side surface section 415 of the device main body 4 and the peripheries of the battery cover 5 and the circuit substrate 6, and adheres closely to the side surface section 415 and the peripheries.

The side wall section 71 includes a groove section 711 which is formed along the peripheries. In addition, the side wall section 71 includes opening sections 712, 713, and 714 on a surface in the Y direction, and includes notch sections 715A and 715B on a surface in the X direction and a surface on a side opposite to the X direction.

In the groove section 711, it is possible to wind the cable CB1 or the cable CB2. In addition, in a case in which the user holds the control device 3, the user can hang a finger on the groove section 711, and thus it is possible to easily grasp the control device 3.

The opening section 712 causes the cable CB1 to be inserted. The opening section 713 exposes the microphone 46, which is included in the device main body 4, from the side wall section 71. The opening section 714 causes the connection section 47, which is included in the device main body 4, to be inserted. The notch sections 715A and 715B cause the engagement pawls 44A and 44B, which are included in the device main body 4, to be inserted.

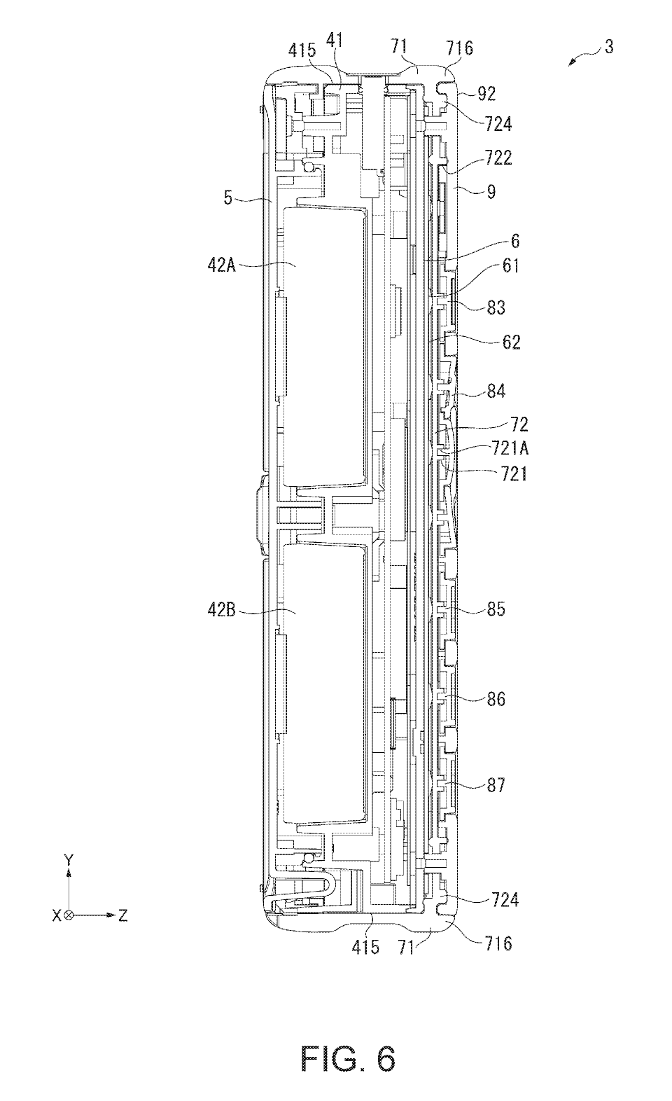

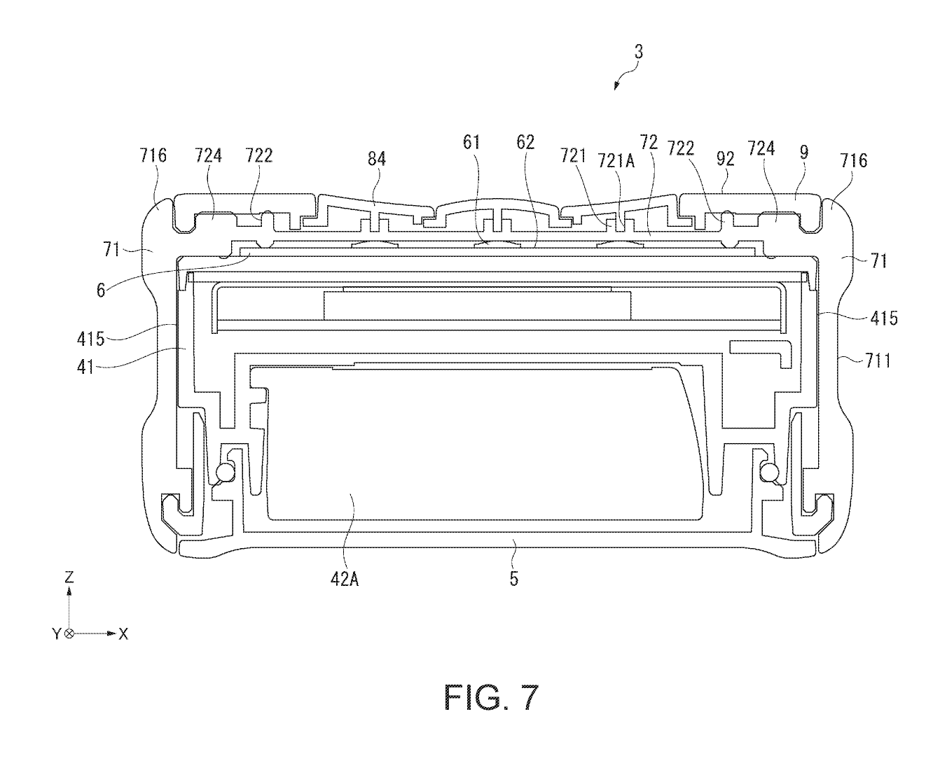

FIG. 6 is a sectional diagram illustrating the control device 3 viewed from the side of the right side surface 3E, and FIG. 7 is a sectional diagram illustrating the control device 3 viewed from the side of the bottom surface 3D.

The side wall section 71 has a thickness dimension which is formed to be greater than a thickness dimension of the front surface section 72, as illustrated in FIGS. 6 and 7. Therefore, it is possible to suppress the thickness dimension of the control device 3 from increasing in a direction along the Z direction and it is possible to sufficiently secure shock resistance to shock toward the device main body 4 from the side of the side surface section 415.

In addition, an end section 716 of the side wall section 71 in the Z direction is located in the Z direction for the front surface section 72. The end section 716 adheres closely to the periphery of the cover member 9 which covers the surface of the front surface section 72 in the Z direction and which will be described later. Therefore, water and dust are prevented from entering between the elastic member 7 and the cover member 9. In addition, the periphery of the cover member 9 is protected from shocks which are given from the outside.

As illustrated in FIGS. 2 to 5, the front surface section 72 covers approximately the whole area of the substrate surface 62 of the circuit substrate 6. In addition, the front surface section 72 includes a plurality of standing sections 721 which stand up in the Z direction, a protruding frame section 722 and a protruding peripheral frame section 724 which extend in the Z direction, and a plurality of hole sections 723.

The standing sections 721 support the key tops 81 to 87. Specifically, the standing sections 721 have a cylindrical shape and are located to correspond to the key tops 81 to 87. As illustrated in FIGS. 6 and 7, the standing sections 721 have recess sections 721A which are open in the Z direction, and support the key tops 81 to 87 by inserting protruding sections, which are included in the key tops 81 to 87 and which will be described later, into the recess sections 721A.

The hole sections 723 are formed on the side of the periphery of the front surface section 72, and fixing sections 93, which are included in the cover member 9 and which will be described later, are inserted to the hole sections 723.

The protruding frame section 722 suppress the water and dust, which intrude from between the key tops 81 to 87 and an opening section 91 of the cover member 9, which will be described later, from adhering to the circuit substrate 6 from the hole sections 723 through the front surface section 72 and the cover member 9. When viewed from a direction along the Z direction, the protruding frame section 722 has a frame shape along the periphery of the front surface section 72, surrounds the key tops 81 to 87, and is formed inside the hole sections 723. Furthermore, the tip of the protruding frame section 722 in the protruding direction (Z direction) adheres closely to the cover member 9. Therefore, it is possible to prevent water and dust, which intrude from between the key tops 81 to 87 and the opening section 91, from moving from the inside of the protruding frame section 722 to the outside through the front surface section 72 and the cover member 9, and it is possible to suppress water and dust from adhering to the circuit substrate 6 from the hole sections 723.

The protruding peripheral frame section 724 suppresses water and dust, which intrude from between the end section 716 of the elastic member 7 and the periphery of the cover member 9, from adhering to the circuit substrate 6 from the hole sections 723 through the front surface section 72 and the cover member 9. The protruding peripheral frame section 724 has a frame shape along the periphery of the front surface section 72 when viewed from the direction along the Z direction, and is formed on the outside of the protruding frame section 722 and the outside of the hole sections 723. Furthermore, the tip of the protruding peripheral frame section 724 in a protruding direction (Z direction) adheres closely to the cover member 9. Therefore, it is possible to prevent water and dust, which intrude from between the end section 716 of the elastic member 7 and the periphery of the cover member 9, from moving from the outside to the inside of the protruding peripheral frame section 724 through the front surface section 72 and the cover member 9, and it is possible to suppress water and dust from adhering to the circuit substrate 6 from the hole sections 723.

### Cover Member

As illustrated in FIGS. 2 to 5, the cover member 9 protects the substrate surface 62 of the circuit substrate 6 from shocks given from the outside. The cover member 9 is formed of a resin material such as plastics, and covers the surface of the front surface section 72 of the elastic member 7 in the Z direction.

In addition, the cover member 9 includes the opening section 91, in which the key tops 81 to 87 are respectively arranged inside, and the fixing sections 93 which protrude on the side of the front surface section 72 of the elastic member 7 on the side of the periphery.

The fixing sections 93 are inserted into the hole sections 723 which are included in the front surface section 72, engaged with the device main body 4 which includes the circuit substrate 6, and configured to fix the cover member 9 and the elastic member 7 to the device main body 4.

Meanwhile, as illustrated in FIGS. 6 and 7, the end section 716 of the side wall section 71 of the elastic member 7 in the Z direction adheres closely to the periphery of the cover member 9, as described above. Here, an exterior surface 92 of the cover member 9 in the Z direction and the outside edge of the end section 716 in the Z direction are present in the same location in a direction along the Z direction.

### Key Tops

The key tops 81 to 87 press the switching elements 61 of the circuit substrate 6 by being pressed down, and change the switching state of the switching elements 61 from an OFF state to the ON state.

The key tops 81 to 87 include an operation section which is pressed by a user finger or the like, protruding sections which press the switching elements 61, and a locking section which is locked in the cover member 9.

Since the key tops 81 to 87 have the same configuration, here, the key top 87 will be described with reference to the accompanying drawings as the representative of the key tops 81 to 87.

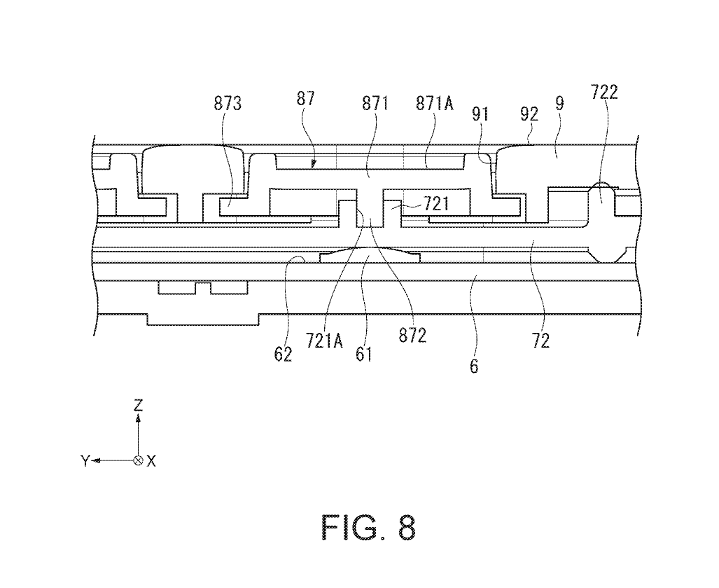

FIG. 8 is an enlarged diagram illustrating a part in the vicinity of the key top 87 in FIG. 6.

As illustrated in FIG. 8, the key top 87 includes an operation section 871 which has approximately a square shape (refer to FIG. 2) when viewed from the direction along the Z direction, a protruding section 872 which protrudes on the side opposite to the Z direction of the operation section 871, and a locking section 873 which extends to the outside from the peripheral edge of the end section of the operation section 871 in a direction opposite to the Z direction.

The operation section 871 is located inside the opening section 91 of the cover member 9. An operation surface 871A of the operation section 871 in the Z direction is exposed from the cover member 9, and is formed to be capable of being touched by the finger of the user. In addition, the operation surface 871A is located on the side opposite to the Z direction for the exterior surface 92 of the cover member 9. Therefore, in a case in which the hand of the user touches the exterior surface 92, it is possible to suppress the operation surface 871A from being unintentionally pressed, and it is possible to prevent malfunction of the key top 87.

The protruding section 872 is inserted into the recess section 721A of the standing sections 721 of the elastic member 7. Therefore, the key top 87 is supported by the elastic member 7. If the operation section 871 is pressed, the protruding section 872 presses the bottom section of the recess sections 721A in a direction opposite to the Z direction. Therefore, the elastic member 7 is bent, the switching element 61 is pressed by the bent elastic member 7, and the switching state of the switching elements 61 is changed from the OFF state to the ON state.

The locking section 873 overlaps the cover member 9 when viewed from a direction along the Z direction, and is located between the front surface section 72 of the elastic member 7 and the cover member 9. Therefore, movement of the key tops 81 to 87 in the Z direction is restricted, and thus the dropout of the key tops 81 to 87 is prevented.

The key top 86 has the same configuration as the key top 87. Although the key tops 81 to 85 have different operation surfaces in shapes and sizes from the key tops 86 and 87, the other configurations are the same. That is, the operation surfaces of the key tops 81 and 82 have approximately a circular shape, the operation surfaces of the key tops 83 and 85 have approximately a rectangular shape, and the operation surface of the key top 84 has approximately a cross shape.

As above, the shapes and sizes of the operation surfaces of the respective key tops 81 to 87 are different from each other, the user can recognize the key tops 81 to 87 by only touching the key tops 81 to 87 without visually observing the key tops 81 to 87. Therefore, it is possible to improve the operability of the control device 3.

Meanwhile, in the embodiment, for example, the key top 81 forms an electric power source key, and the key top 84 forms a cross key (a direction key and a determination key). Furthermore, the operation surface of the key top 84 includes a projection section 841, which protrudes in the Z direction, in the Y direction. According to the configuration, the user can recognize directions of the control device 3 by touching the projection section 841 without visually observing the control device 3. Therefore, it is possible to cause the key tops 81 to 87 to be further easily recognized.

Meanwhile, the control device 3 is used by being stored in, for example, a case which is fixed to clothes which are worn by the user. In the case, for example, a drain hole or the like is provided.

### Advantage of Embodiment

According to the image display system 1 as described above according to the embodiment, there are advantages as below.

Approximately the whole area of the substrate surface 62 of the circuit substrate 6 is covered by the front surface section 72 of the elastic member 7. Therefore, even in a case in which water and dust adhere to the control device 3, it is possible to suppress water and dust from adhering to the substrate surface 62. Accordingly, it is possible to improve waterproof properties and dustproof properties.

Since the side surface section 415 of the device main body 4 is covered by the side wall section 71 of the elastic member 7, it is possible to suppress water and dust from directly adhering to the side surface section 415 and it is possible to suppress water and dust from entering into the inside of the device main body 4 through the side surface section 415. In addition, it is possible to relieve shocks given to the device main body 4 from the side of the side surface section 415 by the side wall section 71, and thus it is possible to improve shock resistance.

In addition, since the side wall section 71 is integrally formed with the front surface section 72, it is possible to reduce the number of components, compared to a case in which the front surface section 72 and the side wall section 71 are formed by separated components. In addition, water and dust do not enter from the boundary between the front surface section 72 and the side wall section 71. In addition, it is possible to simply install the elastic member 7 to the device main body 4 by putting the elastic member 7 on the device main body 4 in which the circuit substrate 6 is installed.

In addition, since the thickness dimension of the side wall section 71 is greater than the thickness dimension of the front surface section 72, it is possible to suppress the increase in the thickness dimension (the dimension of a direction along the Z direction) of the control device 3 and to sufficiently secure shock resistance to shocks given to the device main body 4 from the side of the side surface section 415.

Since the device main body 4 includes the waterproofing sheet 43 which is arranged on the side of the circuit substrate 6, it is possible to suppress water and dust from entering the inside of the device main body 4 from a side which faces the circuit substrate 6 in the device main body 4. Accordingly, it is possible to protect the control substrate 45 which is located in the device main body 4.

In addition, since the storage sections 411 and 412, which store the secondary batteries 42A and 42B of the device main body 4, are covered by the battery cover 5, it is possible to protect the secondary batteries 42A and 42B. Meanwhile, it is possible to suppress water and dust from entering into the storage sections 411 and 412 using the elastic body 54 which is arranged on a contact surface between the battery cover 5 and the device main body 4.

It is possible to support the key tops 81 to 87 using the elastic member 7 by inserting the protruding sections of the key tops 81 to 87 to the recess sections 721A of the elastic member 7. Thereby, compared to a case in which components which support the key tops 81 to 87 are separately provided, it is possible to reduce the number of components and it is possible to simply install the key tops 81 to 87 in the elastic member 7.

Since the front surface section 72 of the elastic member 7 includes the protruding frame section 722, it is possible to suppress water and dust, which intrude from between the key tops 81 to 87 and opening section 91 of the cover member 9, from adhering to the circuit substrate 6 from the hole sections 723 through the front surface section 72 and the cover member 9.

In addition, since the front surface section 72 includes the protruding peripheral frame section 724, it is possible to suppress water and dust, which intrude from between the end section 716 of the elastic member 7 and the periphery of the cover member 9 from adhering to the circuit substrate 6 from the hole sections 723 through the front surface section 72 and the cover member 9.

### Modification of Embodiment

The invention is not limited to the above-described embodiment, and modifications, improvement, or the like in a scope, in which the object of the invention can be accomplished, are included in the invention.

In the embodiment, the elastic member 7 includes the side wall section 71 and the front surface section 72, and covers the substrate surface 62 of the circuit substrate 6 and the side surface section 415 of the device main body 4. However, the invention is not limited thereto. That is, the elastic member 7 may include only the front surface section 72 and may cover only the substrate surface 62.

In addition, in the embodiment, the thickness dimension of the side wall section 71 is greater than the thickness dimension of the front surface section 72. However, the invention is not limited thereto. For example, the thickness dimension of the side wall section 71 may be the same as the thickness dimension of the front surface section 72.

In the embodiment, the detection section, which detects that the key tops 81 to 87 are pressed, includes the switching elements 61. However, the invention is not limited thereto. That is, the detection section may include other components, such as a sensor which can detect that the key tops 81 to 87 are pressed.

In the embodiment, the device main body 4 includes the waterproofing sheet 43 which is arranged on the side of the circuit substrate 6. However, the invention is not limited thereto. That is, the waterproofing sheet 43 may not be provided.

In addition, in the embodiment, the elastic member 7 includes the protruding frame section 722. However, the invention is not limited thereto. For example, if the front surface section 72 of the elastic member 7 does not include a hole such as the hole sections 723, there is a low possibility that water and dust, which intrude from between the key tops 81 to 87 and the opening section 91 of the cover member 9, adhere to the circuit substrate 6, and thus the protruding frame section 722 may be not provided.

In the embodiment, the device main body 4 includes the storage sections 411 and 412, which store the secondary batteries 42A and 42B, and the secondary batteries 42A and 42B. The control device 3 includes the battery cover 5. However, the invention is not limited thereto. For example, in a case in which the control device 3 is directly driven by electric power which is supplied from the AC adaptor through the cable CB2, the storage sections 411 and 412, the secondary batteries 42A and 42B, and the battery cover 5 may be not provided.

In the embodiment, the protruding sections of the key tops 81 to 87 are inserted into the recess sections 721A of the elastic member 7, and thus the key tops 81 to 87 are supported by the elastic member 7. However, the invention is not limited thereto. For example, the key tops 81 to 87 may be supported by the elastic member 7 through a separate configuration, and may be supported by a component which is separate from the elastic member 7.

In the embodiment, the control device 3 includes the cover member 9. However, the invention is not limited thereto. For example, if it is possible to secure the shock resistance to shocks given to the control device 3 from the side of the Z direction by increasing the thickness dimension of the front surface section 72 of the elastic member 7, the cover member 9 may be not provided.

In the embodiment, the shapes and sizes of the operation surfaces of the key tops 81 to 87 are different from each other. However, the invention is not limited thereto. For example, at least any one of the shapes and sizes of the operation surfaces may be different. In addition, all the shapes and sizes of the operation surfaces may be the same. In this case, for example, an edge, which protrudes to the Z direction, may be selectively provided to the key tops 81 to 87 in the peripheries of the operation surfaces such that the key tops 81 to 87 can be recognized by touching the operation surfaces.

In the embodiment, the control device 3 is connected to the image display device 2 through the cable CB1. However, the invention is not limited thereto. That is, the control device 3 may transmit the control signal to the image display device 2 in wireless manner.

In the embodiment, the image display device 2 includes the headband section 21, the display section 22, and the arm section 23. However, the invention is not limited thereto. For example, the image display device may be suspended on the ears and noise of the user using a frame and a temple which support the display section that is arranged in a location corresponding to the eyes of the user. In addition, the display section is not limited to be arranged to cover both the eyes of the user, and may be arranged in a location corresponding to one eye.

In the embodiment, the image display device 2, which displays an image that is visually recognized to the user as the virtual image, is provided as an example of the image display device. However, the invention is not limited thereto. For example, a display unit, such as a liquid crystal panel or an organic Electro-Luminescence (EL) panel, may be provided in the location corresponding to both the eyes of the user.

In addition, it is possible to use a laser retina projection type HMD as the image display device. For example, an HMD may be used in which the display section includes a laser light source and an optical system that guides the laser light source to the eyes of the user, laser light is caused to be incident into the eyes of the user and to scan retinas so as to form an image on the retinas, thereby causing the user to visually recognize the image.

In the embodiment, the control device 3 outputs the operation signal to the image display device. However, the invention is not limited thereto. That is, the invention may be used for a control device which outputs the control signal to another electronic device.

In the embodiment, the control device 3 transmits the operation signal to the image display device 2 based on the detection signal which is output from the circuit substrate 6. However, the invention is not limited thereto. For example, the control device 3 may transmit the detection signal to the image display device 2, and the image display device 2 may generate an operation signal based on the detection signal.

In the embodiment, an example in which the invention is applied to the control device 3 is provided. However, the invention is not limited thereto. For example, in a case in which the key tops are provided in the cases of the head band section 21 and the display section 22 of the image display device 2 and the circuit substrate, which includes the detection section that detects that the key tops in the case are pressed, is provided, the invention may be applied to the image display device 2, thereby accomplishing waterproofing and dustproofing.

In the embodiment, the control signal which is transmitted to the image display device 2 by the control device 3 may include, for example, an operation signal, an image information, and the like which are received by the control device 3 from an external smart phone, a Personal Computer (PC), or the like, in wireless or wired manner.

In the embodiment, the control device 3 has approximately a rectangular parallelepiped shape. However, the invention is not limited thereto. For example, the control device 3 may have various shapes such as a wrist watch type, an oval spherical type, and a cylindrical type.

The entire disclosure of Japanese Patent Application No. 2015-123643, filed Jun. 19, 2015 is expressly incorporated by reference herein.

What is claimed is:

1. A control device comprising:
key tops on which an input operation is performed;
a circuit substrate that includes a detection section which detects that the key tops are pressed on a substrate surface which faces the key tops;
a device main body that is connected to the circuit substrate and is configured to output a signal based on a result of detection performed by the detection section; and
an elastic member that is configured to cover approximately a whole area of the substrate surface and is arranged between the substrate surface and the key tops.

2. The control device according to claim 1,
wherein waterproofing and dustproofing of each of the circuit substrate and the device main body are accomplished in such a way that the elastic member covers at least a part of the device main body.

3. The control device according to claim 2,
wherein the device main body is arranged on the circuit substrate on a side opposite to the substrate surface,
wherein the device main body includes a side surface section that is located in a direction perpendicular to a direction in which the device main body faces the circuit substrate, and
wherein the elastic member includes
a first elastic section that covers the substrate surface, and
a second elastic section that is integrally formed with the first elastic section and is configured to cover the side surface section.

4. The control device according to claim 3,
wherein a thickness dimension of the second elastic section is greater than a thickness dimension of the first elastic section.

5. The control device according to claim 3,
wherein the device main body includes a waterproofing sheet that is arranged on a side of the circuit substrate.

6. The control device according to claim 3,
wherein the device main body is located on a side opposite to the circuit substrate, and is configured to include storage sections that store batteries, and
wherein the control device is installed to be detachable from the device main body and is configured to include a battery cover which covers the storage sections.

7. The control device according to claim 1,
wherein the key tops include protruding sections that protrude on a side of the elastic member, and
wherein the elastic member includes standing sections that are configured to stand on a side of the key tops and are formed with recess sections into which the protruding sections are inserted.

8. The control device according to claim 1, further comprising:
a cover member that is arranged on a side opposite to the circuit substrate while interposing the elastic member, and is configured to include an opening section in which the key tops are arranged inside,
wherein the elastic member includes a protruding frame section that protrudes on a side of the cover member and has a frame shape which surrounds the key tops when viewed from the side of the cover member, and
wherein a tip of the protruding frame section in a protruding direction adheres closely to the cover member.

9. The control device according to claim 1, further comprising:
a cover member that is arranged on a side opposite to the circuit substrate while interposing the elastic member, and is configured to include an opening section in which the key tops are arranged inside,
wherein the cover member includes a fixing section which protrudes on a side of the elastic member,
wherein the elastic member includes a hole section into which the fixing section is inserted, and
wherein the cover member and the elastic member are fixed to the device main body in such a way that the fixing section which is inserted into the hole section is engaged with the device main body, and the elastic member and the cover member adhere closely to each other.

10. An image display system comprising:
the control device according to claim 1; and
an image display device that is mounted on a location corresponding to the head of a user, and is configured to operate according to a signal which is input from the control device.

11. An image display system comprising:
the control device according to claim 2; and
an image display device that is mounted on a location corresponding to the head of a user, and is configured to operate according to a signal which is input from the control device.

12. An image display system comprising:
the control device according to claim 3; and
an image display device that is mounted on a location corresponding to the head of a user, and is configured to operate according to a signal which is input from the control device.

13. An image display system comprising:
the control device according to claim 4; and
an image display device that is mounted on a location corresponding to the head of a user, and is configured to operate according to a signal which is input from the control device.

14. An image display system comprising:
the control device according to claim 5; and
an image display device that is mounted on a location corresponding to the head of a user, and is configured to operate according to a signal which is input from the control device.

15. An image display system comprising:
the control device according to claim 6; and
an image display device that is mounted on a location corresponding to the head of a user, and is configured to operate according to a signal which is input from the control device.

16. An image display system comprising:
the control device according to claim 7; and
an image display device that is mounted on a location corresponding to the head of a user, and is configured to operate according to a signal which is input from the control device.

17. An image display system comprising:
the control device according to claim 8; and
an image display device that is mounted on a location corresponding to the head of a user, and is configured to operate according to a signal which is input from the control device.

18. An image display system comprising:
the control device according to claim 9; and
an image display device that is mounted on a location corresponding to the head of a user, and is configured to operate according to a signal which is input from the control device.
